(19) United States
(12) Patent Application Publication
(10) Pub. No.: US 2017/0153331 A1
(43) Pub. Date: Jun. 1, 2017

(54) LOCATION AND EVENT TRIGGERED NAVIGATION DORMANCY AND WAKEUP

(71) Applicant: QUALCOMM Incorporated, San Diego, CA (US)

(72) Inventor: Arnold Jason Gum, San Diego, CA (US)

(21) Appl. No.: 15/429,419

(22) Filed: Feb. 10, 2017

Related U.S. Application Data
(63) Continuation of application No. 13/325,698, filed on Dec. 14, 2011.

(51) Int. Cl. G01S 19/34; H04W 52/02; H04W 4/02; G01C 21/36

(52) U.S. Cl. CPC G01S 19/34; G01C 21/3661; H04W 52/0254; H04W 4/021; H04W 52/0267

(57) ABSTRACT

A system and method for conditionally transitioning a navigation process on a mobile device between an active state and a reduced activity state are described. In particular, a transition of the navigation process between the active state and the reduced activity state may occur in response to the mobile device approaching a transition location on a predetermined route where the navigation process is to transition to the active state.

### RELATED APPLICATIONS

The present patent application is a continuation of U.S. patent application Ser. No. 13/325,698, filed on Dec. 14, 2011, titled “LOCATION AND EVENT TRIGGERED NAVIGATION DORMANCY AND WAKEUP,” assigned to the assignee of claimed subject matter, and incorporated herein by reference in its entirety.

### BACKGROUND

1. Field

The subject matter disclosed herein relates to control of navigation functions on mobile devices.

2. Information

The Global Positioning System (GPS), and other satellite positioning systems (SPSs), as well as terrestrial-based positioning systems, have enabled navigation capability on mobile devices. For example, by processing SPS signals to obtain pseudorange measurements to measuring transmitters at known locations, a mobile device may estimate its location and obtain a “position fix” that may be utilized for navigation purposes.

Navigation processes are used to guide a user to a pre-designated destination along a route by providing visual and/or audio cues. These applications may allow a user to specify a destination by way of a user interface of a navigation system. Based, at least in part, on a current estimated location (e.g., as determined from a recent position fix), the navigation system may compute a route along known paths, walkways, roads, etc. to a designated destination. The navigation system may then obtain additional position fixes from time to time (e.g., at a particular periodic rate), to provide turn-by-turn directions to the destination. If the mobile device strays from the route, the navigation device may be capable of recomputing the navigation route as needed. While actively navigating, a navigation process may provide a mobile device user with driving, walking or other navigation-related instructions such as when and where to make a turn, when and where to take an on-ramp or off-ramp, how far to proceed on a given highway, proximity to the next action, turn, etc. To do so, the navigation system provides visual and audio cues to guide the user to take actions to navigate to the destination.

### SUMMARY

In one particular embodiment, a method for managing a navigation process on a mobile device comprises: transitioning said navigation process from an active state to a reduced activity state; and transitioning said navigation process to said active state from said reduced activity state in response to receipt of one or more signals indicating that at least one condition has been met, said at least one condition being determined, at least in part, by a transition location on a predetermined route where said navigation process is to transition to said active state.

In another particular embodiment, a mobile device comprises: a receiver to receive radio frequency signals; and a processor to: transition a navigation process from an active state to a reduced activity state to affecting processing of said received signals; and transition said navigation process to said active state from said reduced activity state in response to receipt of one or more signals indicating that at least one condition has been met, said at least one condition being determined, at least in part, by a transition location on a predetermined route where said navigation process is to transition to said active state.

In another particular embodiment, an apparatus for managing a navigation process on a mobile device comprises: means for transitioning said navigation process from an active state to a reduced activity state; and means for transitioning said navigation process to said active state from said reduced activity state in response to receipt of one or more signals indicating that at least one condition has been met, said at least one condition being determined, at least in part, by a transition location on a predetermined route where said navigation process is to transition to said active state.

In yet another particular embodiment, an article comprises a non-transitory storage medium comprising machine-readable instructions stored thereon which are executable by a special purpose computing apparatus to: transition said navigation process on a mobile device from an active state to a reduced activity state; and transition said navigation process to said active state from said reduced activity state in response to receipt of one or more signals indicating that at least one condition has been met, said at least one condition being determined, at least in part, by a transition location on a predetermined route where said navigation process is to transition to said active state.

It should be understood that the above identified embodiments are merely illustrative examples, and that claimed subject matter is not limited to these examples.

### BRIEF DESCRIPTION OF DRAWINGS

Non-limiting and non-exhaustive aspects are described with reference to the following figures, wherein like reference numerals refer to like parts throughout the various figures.

FIG. 1 is a diagram of a portion of a mobile device that is capable of scheduling the operation of navigation functionality according to an embodiment.

FIG. 2A is a schematic diagram of a network topology according to an embodiment.

FIG. 2B shows an image displayed on a display device according to an embodiment.

FIG. 2C is a flow diagram illustrating a process for controlling transitions of a navigation process according to an embodiment.

FIG. 3 is a flow diagram illustrating a process of scheduling navigation functionality in a device according to an implementation.

### DETAILED DESCRIPTION

Methods, components, and systems are provided that may be implemented in a mobile device to trigger the transition of a navigation application from a reduced activity or inactive state to an active state. In a particular embodiment, obtaining a position fix (e.g., by acquiring and processing SPS signals) in combination with provision of navigation services, including audio and visual output instructions at a mobile device, may consume a significant amount of the mobile device's battery resources. With limited battery capacity and a lengthy or time consuming navigation route, a mobile device may expire its battery resources before reaching a destination. This problem may become more acute for long road trips over highways or off-road travel where charging is not readily available for the device. Also, while navigation application software is accessing a screen and audio, other applications such as voice communication service, calendar capability, personal information managers, etc. may be swapped out or otherwise unavailable, sometimes even if the alternative application or feature would be of greater interest to a user at a given instance.

As used herein and as described in greater detail in subsequent sections, various well-known position fixing techniques, as utilized by a navigation process, are contemplated as being within the scope of claimed subject matter. Thus, some implementations may include position fixing obtained through acquiring and processing signals from various broadcasts including, for example, an SPS. In certain example implementations, an SPS may include one or more Global Navigation Satellite Systems (GNSSs), or other like satellite locating services. In other implementations, a position fix may be obtained by way of terrestrial-based systems, devices, and processes such as through the use of time of arrival, triangulation, Advanced Forward Link Trilateration (AFLT), and other trilateration techniques relative to ground-based transmitters/transceivers. In some embodiments, a position fix may be obtained through 3G-or 4G-compatible systems, or may be obtained through processing any one of a large number of signal types that may be received by a mobile device including SPS, wide area network (WAN) signals such as CDMA, LTE, GSM and WCDMA, personal area and medium range network signals such as Bluetooth, WiFi networks, wireless local area network (WLAN), a wireless personal area network (WPAN), worldwide interoperability for microwave access (WiMAX) system, commercial broadcast signals, just to name a few examples. Position determination may also be accomplished or assisted through the use of sensors such as accelerometers, gyros, and magnetometers, either alone or in combination with the processing of wireless signals from the above mentioned signal sources (e.g., WLAN, WAN, WiFi, PAN, and SPS).

In some embodiments, as part of a process to obtain estimates of a position of a receiver for a navigation process, position determination may be accomplished, at least in part, by processing signals received at one or more receivers on the mobile device (e.g., SPS receiver, WAN receiver, and WiFi receivers). Measurements may also be acquired from various sensors such as odometers, accelerometers, gyros, magnetometers, and altimeters. Such measurements may be processed according to various techniques to provide an estimated or predicted location (or position fix), or an estimated or predicted velocity of the receiver as part of an operation of a navigation process or application.

In particular implementations of a navigation process, a user may interact with a user interface of a mobile device to identify a user-selected destination. In this context, a navigation process may be implemented as machine-readable instructions stored in a non-transitory memory for sequential execution by a special purpose computing apparatus as part of a computing application. In particular examples discussed below, a navigation process may exist in any one of several “activity states.” If the mobile device is relatively far from the user-selected destination, position fixes may be scheduled to be performed at a reduced rate (e.g. less often), or not all, in portions of a route to the destination where frequent position fixes are not needed, thereby conserving battery power and/or making the mobile device user interface available for other uses. Here, performing position fixes at a reduced rate may conserve battery resources and make the mobile device available for other applications. Such portions of a route where frequent position fixes are not needed may include, for example, long stretches of highway.

A mobile device scheduling position fixes to be performed at a reduced rate may be considered to be in a reduced activity state or an inactive state. In such an implementation, a navigation process operating on a mobile device may be deactivated or placed in a reduced-power state where, in some embodiments, deactivation of the navigation process may free up the user interface for other applications. However, monitoring of selected sensor output signals may continue after the navigation process has been deactivated or placed in a lower power state to detect conditions in which the navigation application should be reactivated or resume to a full power state. In other embodiments, a navigation process may spawn a separate sensor-monitoring process to monitor sensor output signals, allowing the navigation process to go dormant until it is re-activated or resumed to full power by the sensor-monitoring process. In another embodiment, if a mobile device enters a geographic area where navigation is desired and/or required as detected from monitoring sensor output signals, for example, a navigation process may be reactivated. The reactivated navigation process may then resume scheduling position fixes at an increased rate or a rate sufficient to support active navigation. In some embodiments, a condition for determining whether the navigation process should resume active operation may be detected, at least in part, from periodic location fixes. For example, via SPS or terrestrial signals, a fix may be performed or obtained while a navigation process is deactivated at longer intervals to determine general proximity and to determine proximity of a mobile device to a pre-determined location on the route where the navigation process should be reactivated or resumed to full power. In other embodiments, a presence of local conditions such as a presence of particular signals, or combinations thereof, such as WAN, LAN, and/or WiFi network signals from particular transmitters may initiate a triggering event to reactivate the navigation process to resume full power operation. In still other embodiments, sensor output signals indicating a particular altitude, angle of operation, heading, time or estimated distance such as that derived by an altimeter, accelerometer, magnetometer, clock, odometer, or other sensor may be indicative of a condition for reactivating the navigation process or resuming the navigation process to full power operation. In one example, such a condition may be determined by comparing a current output signal or value with a predetermined output signal or value that is indicative of a location or range of locations where active navigation should resume. In another embodiment, during an inactive state, a sensor output signal indicative of a user shaking of a mobile device or entering a keystroke to a keypad may trigger a transition to an active state.

In some embodiments, a mobile device may conserve power by deactivating a navigation process until a mobile device approaches a destination while a monitoring process executes as a background process to monitor sensor and/or receiver output signals for conditions in which the navigation process should be returned to an active state. Alternatively, a navigation process may continue to execute in a reduced activity mode where it is no longer continuously updating map and audio output but continues to monitor sensor and/or receiver output signals, possibly at a reduced rate, to detect conditions in which the navigation process should be returned to an active state. Accordingly, a user may benefit from a navigation process functioning on a mobile device that is available during a final portion of a user's travel towards a destination or during a portion of the trip that the user designates as benefiting from navigation assistance, without the user stopping to manually reinitiate the navigation process while en route.

In certain implementations, a first component of a mobile device may generate position fixes. In one example implementation, the first component may be capable of functioning as a baseband processor that modulates and demodulates cellular communications signals and may comprise discrete physical processing components of a mobile device. A second component of a mobile device may host a navigation process, and may comprise discrete physical processing components which are separate from the discrete physical processing components of a first component of the mobile device. The second component may control a user interface so that, among other things, updated position fixes and navigation status may be displayed. In still other implementations, both signal processing and application process may be operated on a shared processor.

In some embodiments, a scheduling function for obtaining position fixes and/or other sensor output may be executed by a first component while a second component may be placed in a reduced-power state or deactivated entirely. Such implementations may include an assertion or deassertion of an interrupt signal which may be used, for example, to transition control of a scheduling function from the first component to the second component. In an implementation, scheduling of position fixes by a first component may enable a navigation process to be initiated rapidly in response activation of the second component. Accordingly, in response to activation of the second component, a current estimated location of a mobile device plotted on a map, a time to a destination, and a navigation status may be quickly displayed to a user. Upon activation of a second component, position fixes may be requested at an increased rate (e.g., more often) according to particular timing constraints of a navigation application operating on the second component.

In other implementations, first and second components of a mobile device may be configured in a manner that is alternative to discrete physical components. In one implementation, first and second components may comprise first and second logic or software modules performing computer-implemented methods executed by way of a shared central processing unit under the control of a supervisory control program. In some implementations, the shared central processing unit may be utilized at a reduced operational level while computational demands are decreased, such as through dormancy of a navigation functionality. In an implementation, first and second components may correspond to first and second logic entities (e.g., of a multi-core processor arranged on a single die). In particular implementations, a scheduling transition may correspond to an event posted to initiate passing control of a scheduling function from a first component to a second component. It should be understood, however, that these particular implementations of first and second components are merely reflective of specific system architecture approaches, and that claimed subject matter is not limited in this respect.

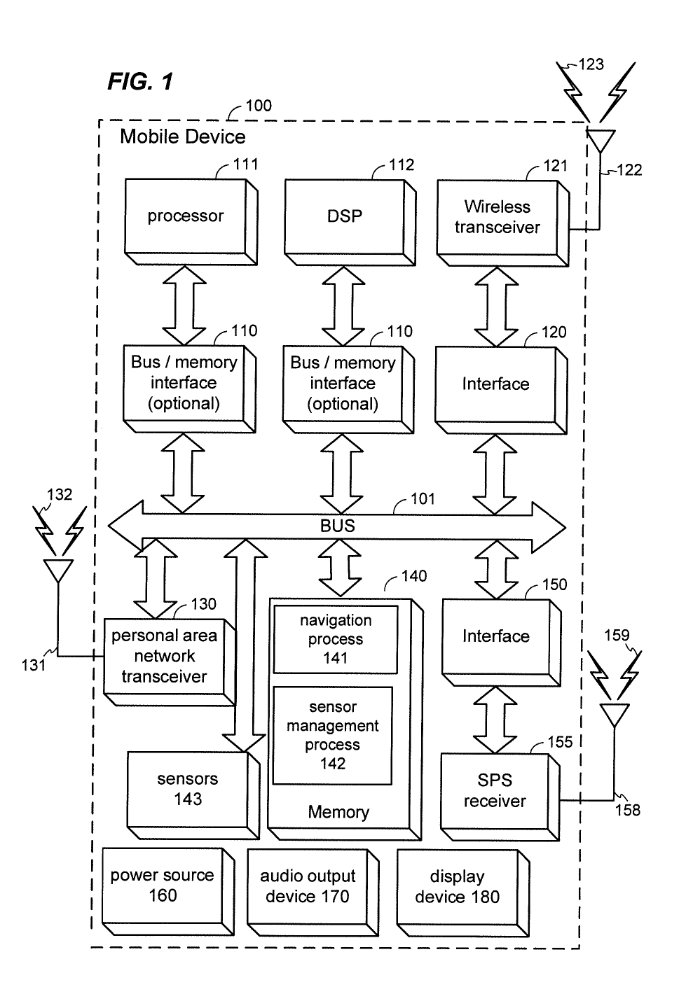

Reference is now made to FIG. 1, which is a diagram of a portion of a mobile device 100 that is capable of operating a navigation process and of location determination according to an implementation. Mobile device 100 may include various computing and communications resources capable of providing position location capability with respect to mobile device 100 based, at least in part, on acquisition of SPS signals 159 via antenna 158 and SPS receiver 155 by way of interface 150 and bus 101; WAN (e.g., CDMA, LTE, WCDMA, UMTS, GSM, AMPS, etc.), WiFi, WiMAX or commercial broadcast signals, or signals from other transmitters positioned at a known location via wireless transceiver 121 and wireless antenna 122, by way of interface 120 and bus 101; and also personal area network signals such as Bluetooth signals via personal area network (PAN) transceiver 130 and PAN antenna 131, which may interface with bus 101. It should be understood, however, that these are merely examples of signals which may be acquired for obtaining a position fix and that claimed subject matter is not limited in this regard. The above-mentioned transceivers and the associated signals received may also be utilized to determine proximity of mobile device 100 to a transition area or location. Here, presence of one or a combination of such signals may be indicative of such a transition area or location, even in the absence of a recent position fix. In some embodiments, mobile device 100 may take the form of a stand-alone navigation circuit or device. In other implementations, mobile device 100 may be integrated either temporarily or permanently into another mobile structure such as an automobile, boat, or airplane. Further, functions performed by mobile device 100 make use of power from power source 160.

In some embodiments, mobile device 100 utilizes a processor 111 or multiple processors to operate upon and/or perform sensor management process 142, navigation process 141, and/or position location process(es) stored in memory 140. Also, in some embodiments, DSP 112 may be utilized to perform part or all of position location processes, sensor processing, audio and/or graphical processing or otherwise operate in conjunction with processor 111 to enable operation of the navigation process, sensor management process, and/or other supporting processes.

In some embodiments, mobile device 100 may include various sensors 143 such as accelerometers, speedometers, odometers, gyros, magnetometers, clocks, inclinometers, and altimeters. In particular embodiments, sensors 143 may generate signals in response to a sensed condition or event. In one example implementation, such signals generated by a sensor may have a value (e.g., voltage or current value) which is representative of a measurement for use (e.g., by itself or in combination with other measurements) in inferring or determining whether a particular condition exists as discussed below. Output signals of sensors 143 may be utilized to enhance or augment position determination and navigation processes by, for example, enhancing the reliability and accuracy of location determination. Sensors 143 may also be utilized to detect a presence of conditions initiating transition the navigation application to an active state such as, for example, a distance traversed, a time elapsed, an altitude, an acceleration or deceleration, a speed, a heading, or triggering angle.

In some embodiments, mobile device 100 may include other circuitry enabling mobile device 100 to perform or support other processes. By way of example, but not limitation, mobile device 100 may take the form of a mobile or portable computing device or machine that may also be capable of communicating with one or more resources within a wireless or wired communication network. Thus, for example, mobile device 100 may comprise a mobile station such as a cellular phone, a smart phone, a personal digital assistant, a portable computing device, a navigation unit, or the like or any combination thereof.

Processor 111 and DSP 112 may, for example, be enabled for use with various wireless communication networks, such as a wireless wide area network (WWAN), a wireless local area network (WLAN), a wireless personal area network (WPAN), 3G, 4G, or LTE (long term evolution) network, just to name a few examples. Mobile device 100 may access wireless communication networks through wireless transceiver 121 and wireless antenna 122, personal area network transceiver 130 and antenna 131, and/or other antenna transceivers located in mobile device 100. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network and so on and/or combinations of the above. A CDMA network may implement one or more radio access technologies (RATs) such as cdma2000, Wideband-CDMA (W-CDMA), to name just a few radio technologies. Herein, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example.

In a particular implementation, processor 111, or other applications processor, may initiate position determination as requested by a particular navigation application executing on processor 111. If position determination is requested, signals 123, 132, and/or 159 received through wireless antennas 122, 131, and/or 158, respectively, may be processed by wireless transceiver 121, personal area network transceiver 130, and/or SPS receiver 155, respectively. DSP 112 and/or processor 111, may compute a position fix as a result of analyzing one or more signals 123, 132, and 159. Such a position fix may be utilized by processor 111, DSP 112, or other processor for the provision of navigation services by processor 111, which may interface with bus 101 by way of bus/memory interface 110 . In some embodiments, position fixes may be used by the navigation application to calculate route, to determine progress and location along the route, and to detect route deviation and re-calculate route recommendations.

In an embodiment, mobile device 100 includes display device 180 to display maps, navigation directions, progress updates and other information, provided by navigation process 141, for output through the user interface such as audio output device 170 and display device 180. Mobile device 100 includes audio output device 170, which may be used to transmit audible instructions to the user of mobile device 100. In some embodiments, other user interface devices may also be utilized such as tactile feedback through the use of vibration devices. Also, in some embodiments, additional or different navigation parameters may be displayed, and claimed subject matter is not limited in this respect.

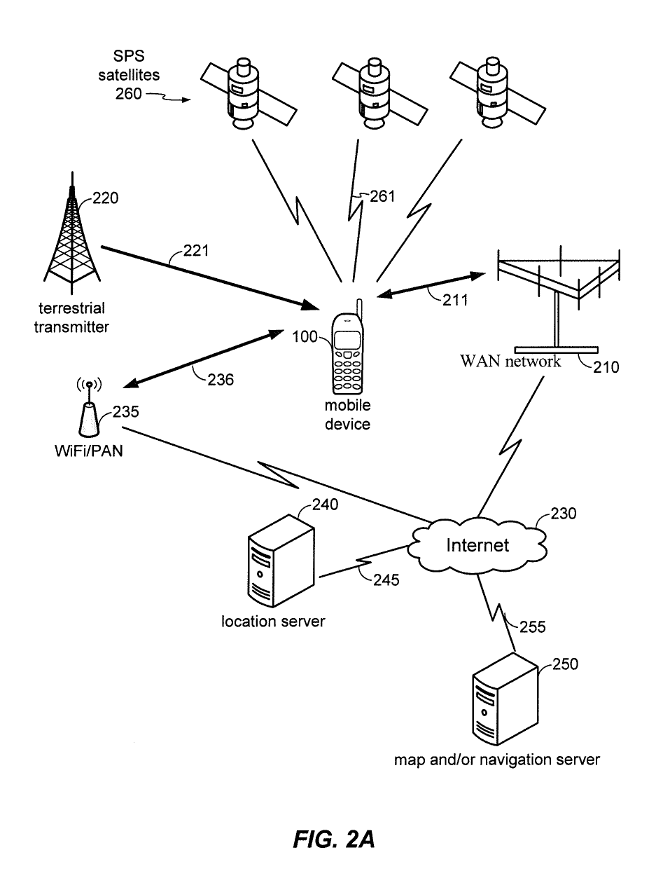

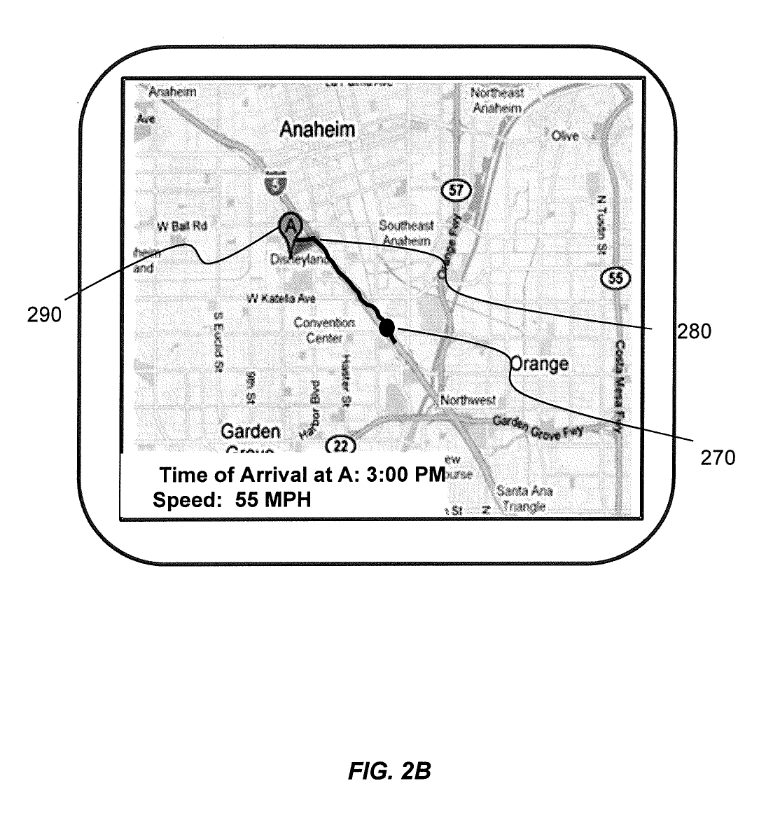

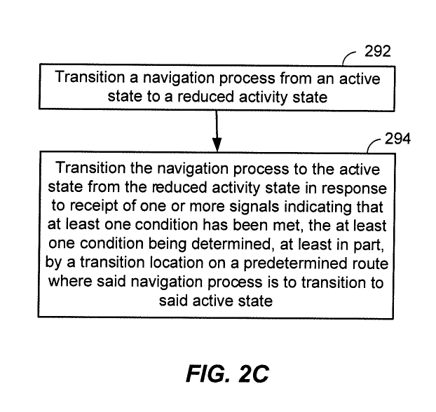

In the embodiment illustrated in FIG. 2A, mobile device 100 may be capable of receiving SPS signals 261 from one or more SPS constellations such as SPS satellites 260.

In an embodiment, mobile device 100 is capable of receiving and processing WAN signals from WAN network 210 via WAN network signals 211. WAN networks may include but are not limited to may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as, for example, cdma2000, Wideband-CDMA (W-CDMA), and so on. Cdma2000 may include IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma 2000 is described in documents from a consortium named “3rd Generation Partnership Project 2” (3GPP2). 3GPP and 3GPP2 documents are publicly available.

In an embodiment, mobile device 100 is capable of communicating via WiFi and Personal Area Networks (PAN) 235, such as an IEEE 802.11x network or some other type of network, via WiFi/PAN signals 236. A WPAN may be, for example, a Bluetooth network, an IEEE 802.15x network, or some other type of network. Techniques disclosed herein may also be implemented in conjunction with any combination of WWAN, WLAN, and/or WPAN.

In an embodiment shown in FIG. 2B, mobile device 100 is capable of receiving terrestrial transmitter signals 221 such as digital radio broadcasts transmitted by a terrestrial transmitter 220.

In an embodiment, SPS signals 261, WAN network signals 211, WiFi/PAN signals 236 and/or terrestrial transmitter signals 221 may be processed for obtaining a position fix, assisting in the navigation process and/or determining whether a particular waypoint in a route has been reached. For example, in an embodiment, presence of terrestrial transmitter signal 221, e.g., a signal transmitted by a particular radio station, may be processed to determine that the mobile device is in an area or portion of a navigation route where navigation should transition to an active state. Similarly, presence of WiFi/PAN signals 236 with particular SSIDs or SSIDs in a particular combination and/or the presence of WAN Network signals 211 with particular base station IDs (BSID) or a combination thereof may be processed to determine that the mobile device is in an area or portion of a navigation route where navigation should transition to an active state.

In an embodiment, a location server 240, map and/or navigation server 250, or other information server may send location related information through communications link 245 or 255, respectively, by way of Internet 230, to the mobile device 100. In an embodiment, location related information may include a transmitter almanac identifying signals detectable in a bounded area(s), or portion(s), or geofence(s) of a navigation route where a navigation process should be transitioned to an active state. In a particular example implementation, location related information may include a transmitter almanac that identifies signals detectable along a route to a destination. In yet another embodiment, location related information may include a transmitter almanac identifying signals detectable over a large geographic area, including signals visible at the mobile device's destination location.

In one particular implementation, a user may select to define a geographic area surrounding destination by way of interacting with a user interface of mobile device 100. For example, a user may interact with a touchscreen to draw or portray a circle (or an approximation thereof) or other shape to at least partially surround destination 290 (FIG. 2B). In an implementation, a user may be presented with a menu in which radii of certain sizes may be selected or, in another implementation, the user may be presented with a default-sized geographic area. However, these are merely exemplary implementations of how a user may define an area surrounding a destination, and claimed subject matter is not limited in this respect.

According to particular embodiments, navigation process 141 may be placed in any one of multiple “activity states” to, as indicated elsewhere herein, conserve battery resources and/or make processing resources on a mobile device available to other processes. In this context, navigation process 141 may be placed in an “active state” in which particular features of navigation process 141 are enabled. Such features may include, by way of example but not limitation, turn-by-turn navigation, full control of a display device or audio device or active SPS navigation functions. In contrast with being in an active state, navigation process 141 may be placed in a “reduced activity state” in which one or more features of enabled in an active state are disabled or turned off. One particular example of a reduced activity state may include an “inactive state” in which at least some features are made dormant (e.g., turn by turn navigation, SPS navigation, use of display or audio devices) while other features are enabled (e.g., sensor monitoring, infrequent updates regarding a proximity to a transition point, etc.). In another particular example, a transition to a reduced activity state may occur in response to an inference that the mobile device is located on a particular stretch of highway. Here, an SPS receiver may be placed in a reduced power state while another receiver (e.g., cellular communication receiver) from time-to-time obtains updates on a proximity to a destination based, at least in part, on acquisition of signals from terrestrial transmitters at known locations (e.g., as indicated in a base station almanac or other signal almanac).

In an embodiment, mobile device 100 transitions navigation process 141 to a reduced activity or dormant state until transition location 280 is reached. While in a reduced activity or dormant state, navigation process 141 may monitor output signals received from wireless transceiver 121, personal area network transceiver 130, SPS transceiver 155 and/or sensors 143 to determine whether transition location 280 has been reached. In an embodiment, navigation process 141 may be placed into a dormant state while sensor management process 142 monitors output signals received from wireless transceiver 121, personal area network transceiver 130, SPS transceiver 155 and/or sensors 143 to determine whether transition location 280 has been reached. In an embodiment, during a reduced activity state or dormant state, navigation process 141 may reduce or suspend accesses to audio output device 170 and/or display device 180, and/or otherwise reduce access and loading of processor 111. In an embodiment, while in a reduced activity state or dormant state, navigation process 141 may reduce a rate of position determination cycles, or suspend position determination operations altogether. In an embodiment, while navigation process 141 is in a reduced activity state or dormant state, processor 111, audio output device 170, and display device 180 may be allocated to or used by other processes or applications.

In an embodiment, while navigation process 141 is in a reduced activity state, or sensor management process 142 determines that transition location 280 has been reached by mobile device 100, processor 111 may return navigation process 141 to an active state. In an embodiment, sensor management process 142 may notify processor 111 that transition location 280 has been reached via hardware interrupt or programmatic call.

FIG. 2C is a flow diagram illustrating a process for controlling transitions of a navigation process according to an embodiment. At step 292, a navigation process is transitioned from an active state to a reduced activity state. Subsequently, at step 294, the navigation process is transitioned from the reduced activity state to the active state in response to receipt of one or more signals indicating that at least one condition has been met. Here, the at least one condition may be determined, at least in part, by a transition location on a predetermined route where the navigation process is to transition to the active state.

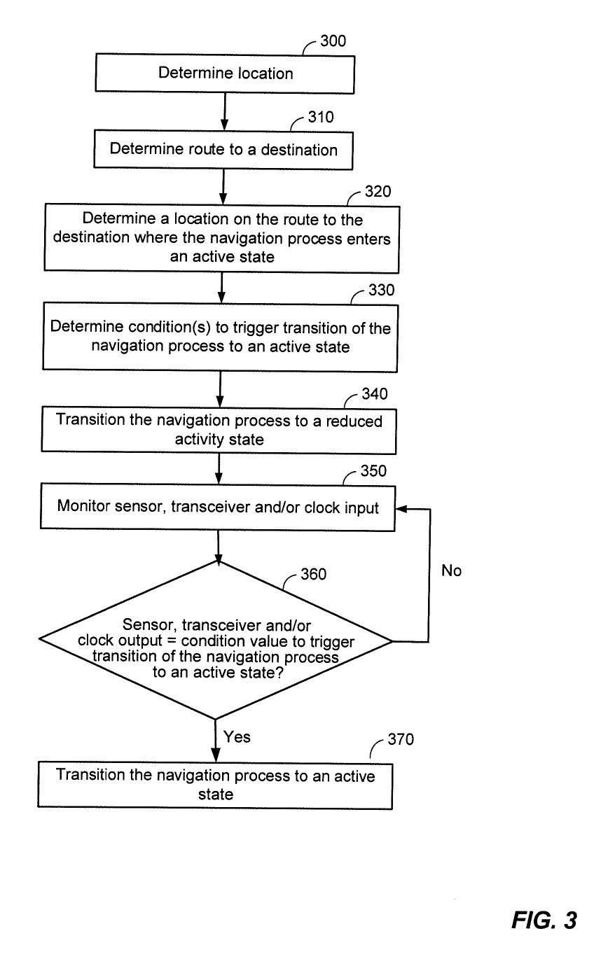

FIG. 3 is a flow chart illustrating a process of obtaining position fixes in a device according to an embodiment. Although the embodiment of FIG. 1 may be suitable for performing the method of FIG. 3, other structures or devices may perform the method of FIG. 3 without deviating from claimed subject matter. The method of FIG. 3 begins at step 300, where a mobile device obtains an estimate of its location to provide a point of origin 270. In an embodiment, the estimated location may be determined by various means such as through SPS signals 261, WAN network signals 211, WiFi/PAN signals 236, terrestrial transmitter signals 221, sensors 143 and/or through user input as pointed out in examples discussed above. In an embodiment, a start time along a route may be determined in response to determination of point of origin 270. Alternatively, a start time may be determined in response to detection of movement of the mobile device along the route.

Step 310 determines a route to a destination pre-specified by the use, according to an embodiment. Such specification of a destination by a user may occur prior to step 300. A route between the location determined in step 300 and the pre-specified destination may be computed. Here, such a route may be computed by mobile device 100 utilizing stored map data. Alternatively, such a route may be computed externally on a route server which computes a route and returns the computed route to mobile device 100. In an embodiment, a route may be specified or expressed as turn-by-turn steps between the point of origin 270 and the destination 290. The route computed route may be provided with map information for an area to be traversed along the computed route and surrounding areas between the point of origin 270 and the destination 290.

Step 320 may determine a location on a computed route to the destination at which navigation process 141 is to enter an active state. Here, a user may specify transition location 280 as a location or a condition to be satisfied for transitioning navigation process 141 to an active state. For example, in an embodiment, a user may specify a step in instructions specifying a computed route such as, “exit highway at exit 240.” In an embodiment, a step in instructions specifying a computed route may be used to determine a location along a route where navigation process 141 is to transition to an active state based, at least in part, on the location where that step in the route instructions would occur.

In determining a location on a computed route where navigation process 141 is to enter an active state, step 320, according to an embodiment, may receive selections at a touch screen overlaying a screen displaying a map of the computed route. For example, the computed route, or a part thereof, may be displayed on display device 180. A user may touch a portion of a touchscreen over a displayed part of a computed route, possibly in combination with a command or key press, to designate a location on the route where navigation process 141 is to enter an active state (e.g., where active navigation and/or turn by turn navigation is desired). In other embodiments, a location on the route where navigation process 141 is to enter an active state may be controlled by keypad entries without the use of a touchscreen. In other embodiments, a location on the route where navigation process 141 is to enter an active state may be controlled by voice recognition of user commands.

In determining a location on a computed route where navigation process 141 is to enter an active state, step 320, in an alternative embodiment, may receive user selections of a named waypoint along the computed route. For example, if a computed route extends through a plurality of cities, a user may specify a city, cities, or other waypoints where turn-by-turn navigation is desired and where navigation process 141 is to return to an active state. In an another alternative embodiment, step 320 may determine a location on a computed route where navigation process 141 is to enter an active state responsive to a default condition such as mobile device 100 moving off the highway, passing through a town, and/or approaching a highway exit.

In an embodiment, navigation process 141 may transition to an active state in anticipation of reaching transition location 280 so as to be fully active when transition location 280 is reached. For example, if odometer measurements or other measure of traversed distance is used for computing a distance traveled, a distance short of the distance from point of origin 270 to transition location 280 may be utilized to trigger a transition of navigation process 141 to an active state. Similarly, detection of signals that are expected to be visible at transition location 280 may initiate an anticipatory transition of navigation process 141 to an active state before the transition point is actually reached. If a particular location is used to determine whether transition location 280 has been reached, a location along the route prior to reaching the transition location 280 or within a proximity of a predetermined distance may define location(s) where navigation process 141 is to transition to an active state. In particular embodiments, specifying an approximate location for a transition location 280, instead of an exact location of transition location 280, to determine whether transition location 280 has been reached may allow greater tolerance to a reduced rate of position fixes during dormancy. Step 330 may determine condition(s) to trigger transition of navigation process 141 to an active state determined based, at least in part, on a location of mobile device 100 and/or a value or range of values of measurements obtained from monitored sensors or receivers. Therefore, if a location of mobile device 100 defines one of such conditions, a location or area within a fixed proximity of the transition location 280 may be designated as a condition initiating transition of navigation process 141 to an active state.

In a particular embodiment, transition to an active state may also happen in response to or subsequent to mobile device 100 reaching transition location 280. It may be useful, however, for an application to make a user aware or provide a choice to the user as to whether navigation process 141 is to transition to an active state prior to, at or after the transition location 280 is reached. In an embodiment, wireless signals present near the transition location 280 may be selected out of an almanac of wireless transmitters, or otherwise specified, and at least covering the area near the transition location 280. Detection of these wireless signals near the transition location 280 may, in an embodiment, initiate transition of navigation process 141 to an active state.

As noted above, sensor output signals received from an odometer, pedometer, accelerometer, gyro or change input from various sensors, may be indicative of conditions to trigger transition of navigation process 141 to an active state.

In step 340, once a computed route-transition location 280 and associated triggering conditions are determined, navigation process 141 may be transitioned to a reduced activity and/or dormant state during which either navigation process 141 or a sensor management process 142 monitors received wireless signals, sensor output signals, clock signals and/or other triggering conditions to determine whether transition location 280 has been, or will shortly be reached. During a dormant and/or reduced activity state, navigation process 141 may reduce or stop access to audio output device 170, display device 180 and/or processor 111. This may also include reducing a rate of position location versus what would be desired for turn-by-turn navigation. For example, if one position fix per second is desired for turn-by-turn navigation, a rate of position location/fixes may be reduced to once every five minutes or longer while in the dormant state. A rate of location fixes may also be increased as mobile device 100 approaches transition location 280. It is noted that the transition of navigation process 141 to a reduced activity state may, in an embodiment, be triggered by user input. However, in an embodiment, transition of navigation process 141 to a reduced activity state may also be performed automatically. For example, if mobile device 100 is on a highway and a computed route shows that mobile device 100 is likely to remain on the highway for a long period of time and/or a long distance, mobile device 100 may automatically transition to a lower activity state, freeing up resources such as the display device 180, audio output device 170, and processor 111, or parts thereof, for alternative uses.

In step 350, navigation process 141 operating in a reduced activity state or sensor management process 142 (in lieu of the navigation process 141) may monitor sensor, transceiver, and/or clock output signals. Step 360 may compare the received output signals against triggering condition values or ranges of values determined in Step 330. In step 360, if sensor, transceiver and/or clock output signals match condition value(s) to trigger transition of the navigation process to an active state, navigation process 141 may be transitioned to an active state. Sensor management process 142, if active, may be terminated. In step 360, if sensor, transceiver, and/or clock output signals do not match condition value(s) for triggering transition of navigation process 141 to an active state, then, monitoring processes in step 350 may be continued. In step 360, if sensor, transceiver, and/or clock output signals does match condition value(s) for triggering transition of navigation process 141 to an active state, then, the navigation process may transition to an active state in step 370.

Techniques described herein may be used with an SPS that includes any one of several GNSS or combinations of GNSS. An SPS may include a system of transmitters positioned to enable entities to determine their location on or above the Earth based, at least in part, on signals received from the transmitters. Such a transmitter may transmit a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented

Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS. Furthermore, such techniques may be used with positioning systems that utilize terrestrial transmitters acting as “pseudolites”, or a combination of SVs and such terrestrial transmitters. The terms “SPS signals,” as used herein, is intended to include SPS-like signals from terrestrial transmitters, including terrestrial transmitters acting as pseudolites or equivalents of pseudolites.

Reference throughout this specification to “one example”, “an example”, “certain examples”, or “exemplary implementation” means that a particular feature, structure, or characteristic described in connection with the feature or the example may be included in at least one feature or example of claimed subject matter. Thus, the appearances of the phrase “in one example”, “an example”, “in certain examples” or “in certain embodiments” or other like phrases in various places throughout this specification are not necessarily all referring to the same feature, example, or limitation. Furthermore, the particular features, structures, or characteristics may be combined in one or more examples or features.

The methodologies described herein may be implemented by various measures depending upon applications according to particular features or examples. For example, such methodologies may be implemented in hardware, firmware, or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “transitioning,” “scheduling,” “activating,” “deactivating,” “accepting,” “conveying,” “deriving,” “updating,” “determining”, “establishing”, “obtaining”, or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method for a mobile device, the method comprising:
determining an estimated location of the mobile device at a first rate based, at least in part, on a plurality of received wireless signals; and
transitioning the mobile device to a reduced activity state comprising, at least in part, determining the estimated location of the mobile device at a second rate, wherein transitioning the mobile device to the reduced activity state is at least partly in response to a comparison of the estimated location of the mobile device and a transition location.

2. The method of claim 1, wherein the reduced activity state further comprises providing a navigation process at a reduced rate.

3. The method of claim 2, wherein providing the navigation process at the reduced rate comprises providing audio and visual output instructions at a reduced rate.

4. The method of claim 1, wherein transitioning the mobile device to the reduced activity state comprises acquisition of one or more wireless signals indicating a service set identifier (SSID) or set of SSIDs corresponding to the transition location.

5. The method of claim 1, wherein transitioning the mobile device to the reduced activity state comprises acquisition of one or more wireless signals indicating a base station identifier (BSID) or set of BSIDs corresponding to the transition location.

6. The method of claim 1, wherein transitioning the mobile device to the reduced activity state comprises determining that the estimated location of the mobile device is associated with a geographic area corresponding to the transition location.

7. The method of claim 6, wherein the geographic area comprises a bounded area or geofence.

8. A mobile device comprising:
a receiver to receive wireless signals; and
a processor to:
determine an estimated location of the mobile device at a first rate to be based, at least in part on one or more wireless signals received at the receiver; and
transition the mobile device to a reduced activity state to comprise, at least in part, determination of the estimated location of the mobile device at a second rate, wherein to transition the mobile device to the reduced activity state is to be at least partly in response to a comparison of the estimated location of the mobile device and a transition location.

9. The mobile device of claim 8, wherein the reduced activity state is further to comprise provision of a navigation process at a reduced rate.

10. The mobile device of claim 9, wherein provision of the navigation process at the reduced rate comprises provision of audio and visual output instructions at a reduced rate.

11. The mobile device of claim 8, wherein to transition the mobile device to the reduced activity state is to comprise acquisition of one or more wireless signals indicating a service set identifier (SSID) or set of SSIDs corresponding to the transition location.

12. The mobile device of claim 8, wherein to transition the mobile device to the reduced activity state is to comprise acquisition of one or more wireless signals indicating a base station identifier (BSID) or set of BSIDs corresponding to the transition location.

13. The mobile device of claim 8, wherein to transition the mobile device to the reduced activity state is to comprise a determination that the estimated location of the mobile device is associated with a geographic area corresponding to the transition location.

14. The mobile device of claim 13, wherein the geographic area comprises a bounded area or geofence.

15. An apparatus comprising:
means for determining an estimated location of the mobile device at a first rate based, at least in part, on a plurality of received wireless signals; and
means for transitioning the mobile device to a reduced activity state comprising, at least in part, determining the estimated location of the mobile device at a second rate, wherein the means for transitioning the mobile device to the reduced activity state comprises means for transitioning the mobile device to the reduced activity state at least partly in response to a comparison of the estimated location of the mobile device and a transition location.

16. The apparatus of claim 15, wherein the means for transitioning the mobile device to the reduced activity state further comprises means for providing a navigation process at a reduced rate.

17. The apparatus of claim 16, wherein the means for providing the navigation process at the reduced rate comprises means for providing audio and visual output instructions at a reduced rate.

18. The apparatus of claim 15, wherein the means for transitioning the mobile device to the reduced activity state comprises means for acquiring one or more wireless signals indicating a service set identifier (SSID) or set of SSIDs corresponding to the transition location.

19. The apparatus of claim 15, wherein the means for transitioning the mobile device to the reduced activity state comprises means for acquiring one or more wireless signals indicating a base station identifier (BSID) or set of BSIDs corresponding to the transition location.

20. The apparatus of claim 15, wherein the means for transitioning the mobile device to the reduced activity state comprises means for determining that the estimated location of the mobile device is associated with a geographic area corresponding to the transition location.
